(19) United States
(12) Patent Application Publication
(10) Pub. No.: US 2024/0007917 A1
(43) Pub. Date: Jan. 4, 2024

(54) DYNAMIC QUANTIZATION OF ARTIFICIAL INTELLIGENCE OR MACHINE LEARNING MODELS IN A RADIO ACCESS NETWORK

(71) Applicant: Intel Corporation, Santa Clara, CA (US)

(72) Inventors: Vaibhav SINGH, New Delhi (IN); Christian MACIOCCO, Portland, OR (US)

(21) Appl. No.: 17/896,085

(22) Filed: Aug. 26, 2022

(30) Foreign Application Priority Data
Jun. 29, 2022 (IN) 202241037446

(51) Int. Cl. H04W 36/06; H04L 25/49; H04W 36/30; H04W 36/22

(52) U.S. Cl. CPC H04W 36/06; H04L 25/4927; H04W 36/30; H04W 36/22

(57) ABSTRACT

A wireless communication device including a memory configured to store instructions; a processor coupled to the memory configured to execute the instructions stored on the memory, wherein the instructions are configured to receive a request message to update a radio access network (RAN) quantization scheme; determine an updated quantization scheme based on properties of a RAN; determine if the updated quantization scheme satisfies a RAN performance criterion; and generate a message including instructions for the updated quantization scheme.

### RELATED APPLICATIONS

The present application claims priority from Indian application No. 202241037446 filed on Jun. 29, 2022, which is incorporated herein by reference in its entirety.

### TECHNICAL FIELD

This disclosure may generally relate to the field of wireless communications.

### BACKGROUND

As Open RAN (O-RAN) standards develop, the responsibility to define standards for interfaces enabling different functionalities of the radio access network (RAN) fall on the Ran Intelligent Controller (RIC). The RIC may optimize different functionalities of the RAN by making data driven choices in an open platform. The RIC may be exposed to terabytes (TBs) of data from multiple cells. Artificial intelligence (AI) and machine learning (ML) algorithms which may be based on Radio Resource Management (RRM) algorithms use the TBs of data from the multiple cells as input. The RRM algorithms may be designed to learn patterns from the TBs of data. For example, algorithms may learn patterns of users, network traffic, mobility, etc., to optimize RAN operations or functionalities. RAN operations or functionalities which may be improved based on the learned patterns include load balancing, Channel Quality Indicator (CQI) period optimization, connectivity optimization, energy saving etc. The algorithms may optimize RAN operations or functionalities after learning past behaviors supported by the RAN. Artificial intelligence and/or machine learning (AI/ML) models for Load Prediction, Spectral efficiency prediction, Traffic prediction etc. may serve as the basis for the RRM algorithms. The AI/ML models for different RAN algorithms may be constantly updated using training based on the data from multiple cells in the network. For example, logic of the RIC may include criterion for the AI/ML models and compare the current models against the criterion and updated them accordingly. Complex AI/ML models may incur time delays. For example, deep neural networks (DNNs) and transformers may cause high latency in generating an inference or prediction. Training the AI/ML models and generating an inference or prediction may require high platform computation. It would be beneficial to generate a prediction algorithm which can serve as the basis for multiple RRM algorithms and components, to reduce latency, computation, and power consumption dynamically without affecting RAN performance.

### BRIEF DESCRIPTION OF THE DRAWINGS

In the drawings, like reference characters generally refer to the same parts throughout the different views. The drawings are not necessarily to scale, emphasis instead generally being placed upon illustrating the exemplary principles of the disclosure. In the following description, the disclosure may be described with reference to the following drawings, in which:

FIG. 1 illustrates an exemplary radio communication network.

FIG. 2 illustrates an exemplary internal configuration of a terminal device.

FIG. 3 illustrates an exemplary flow chart for reducing computation and power consumption in a radio access network (RAN).

FIG. 4 illustrates an exemplary solution in artificial intelligence (AI) computing for a RAN.

FIG. 5 illustrates an exemplary algorithm for dynamic quantization.

FIG. 6 illustrates an exemplary method for dynamic quantization.

### DETAILED DESCRIPTION

In the following detailed description, numerous specific details are set forth in order to provide a thorough understanding of some examples. However, it will be understood by persons of ordinary skill in the art that some examples may be practiced without these specific details. In other instances, well-known methods, procedures, components, units and/or circuits have not been described in detail so as not to obscure the discussion.

AI or ML based RRM algorithms for single or multiple mobile radio cells are trained on RAN data collected from the single or multiple cells. For example, RRM algorithms may include multi-layered deep learning models configured for hundreds of inputs and include multi-layered transformer models with attention layers. This complexity of these RRM algorithms may require very high computational power for training the models or algorithms. For example, very high computations may require 2 to 3 days of training on a server CPU. This may be true for both offline and online training. Additionally, the high computations may be required for generating an inference or prediction which may lead to latency in determining an inference or prediction.

It would be advantageous to have a dynamic RAN quantization module to determine the optimal quantization scheme or model for the input data of the AI or ML models of an RRM algorithm. The dynamic quantization scheme can quantize the input data based on RAN properties with respect to the number of cells and the time. A dynamic RAN quantization module (DRQM) can use the RAN properties to determine the granularity of the quantization scheme for the AI/ML based RRM algorithms. The granularity of the quantization scheme may be determined by a complex model with multidimensional input data of RAN properties or characteristics and RAN performance data. Further, the model ‘learns’ which quantization scheme works on the fly. The RAN AI/ML based RRM algorithms may be complex and include high computation requirements and high prediction latency. Updating the quantization scheme may reduce the complexity of an AI/ML model or algorithm. The number of mobile radio cells, and time in the context of a RAN may affect the optimal quantization scheme. An optimal quantization scheme for an RRM algorithm in a cell may be suboptimal for a different cell or may be suboptimal for the same cell at a different time. Dynamic quantization of the AI/ML models may save power on the controller platform or gNB/eNB, while maintaining RAN performance. Additionally, dynamic quantization may minimize the amount of input data and processor overhead. Finally, dynamic quantization may be suitable to implement over a controller platform, such as RIC running on computer Architecture.

An exemplary DRQM algorithm may input data from one or more AI/ML models of the RRM algorithm. For example, the DRQM may take RAN properties as input such as DRQM cell environment, sample history, and statistics for DL PRB usage, number of radio resource controls (RRC) connected users, incident traffic, number of active users, user density, average UE mobility, cell configuration parameters, cell geography etc. of one or more cells.

Additionally, RAN performance may be input data for a DRQM algorithm and includes sample history and statistics of latency, cell/UE throughput, cell/UE spectral efficiency, power used, CPU cycles used etc. for a one or more cells.

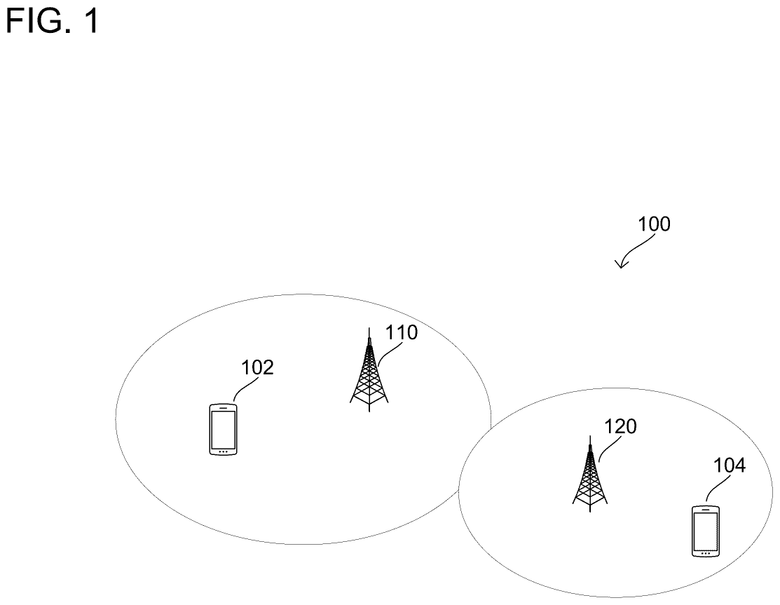

FIG. 1 shows exemplary radio communication network 100, which may include terminal devices 102 and 104 and network access nodes 110 and 120. Radio communication network 100 may communicate with terminal devices 102 and 104 via network access nodes 110 and 120 over a radio access network. Although certain examples described herein may refer to a particular radio access network context (e.g., Long Term Evolution (LTE), Universal Mobile Telecommunications System UMTS, Global System for Mobile Communications (GSM), other 3rd Generation Partnership Project (3GPP) networks, Wireless Local Area Network (WLAN)/Wireless Fidelity (Wi-Fi), Bluetooth, Fifth Generation (5G) New Radio (NR), Millimeter Wave (mmWave), Wireless Gigabit Alliance (WiGig), etc.), these examples are illustrative and may be readily applied to any other type or configuration of radio access network. The number of network access nodes and terminal devices in radio communication network 100 is exemplary and is scalable to any amount.

In an exemplary cellular context, network access nodes 110 and 120 may be base stations (e.g., eNodeBs, NodeBs, Base Transceiver Stations (BTSs), gNodeBs, or any other type of base station), while terminal devices 102 and 104 may be cellular terminal devices (e.g., Mobile Stations (MSs), User Equipments (UEs), or any type of cellular terminal device). Network access nodes 110 and 120 may therefore interface (e.g., via backhaul interfaces) with a cellular core network such as an Evolved Packet Core (EPC, for LTE), Core Network (CN, for UMTS), or other cellular core networks, which may also be considered part of radio communication network 100. The cellular core network may interface with one or more external data networks. In an exemplary short-range context, network access node 110 and 120 may be access points (APs, e.g., WLAN or Wi-Fi APs), while terminal device 102 and 104 may be short range terminal devices (e.g., stations (STAs)). Network access nodes 110 and 120 may interface (e.g., via an internal or external router) with one or more external data networks.

Network access nodes 110 and 120 (and, optionally, other network access nodes of radio communication network 100 not explicitly shown in FIG. 1) may accordingly provide a radio access network to terminal devices 102 and 104 (and, optionally, other terminal devices of radio communication network 100 not explicitly shown in FIG. 1). In an exemplary cellular context, the radio access network provided by network access nodes 110 and 120 may enable terminal devices 102 and 104 to wirelessly access the core network via radio communications. The core network may provide switching, routing, and transmission, for traffic data related to terminal devices 102 and 104, and may further provide access to various internal data networks (e.g., control nodes, routing nodes that transfer information between other terminal devices on radio communication network 100, etc.) and external data networks (e.g., data networks providing voice, text, multimedia (audio, video, image), and other Internet and application data). In an exemplary short-range context, the radio access network provided by network access nodes 110 and 120 may provide access to internal data networks (e.g., for transferring data between terminal devices connected to radio communication network 100) and external data networks (e.g., data networks providing voice, text, multimedia (audio, video, image), and other Internet and application data).

Communication protocols may govern the radio access network and the core network of radio communication network 100. Communication protocols can vary depending on the specifics of radio communication network 100. Such communication protocols may define the scheduling, formatting, and routing of both user and control data traffic through radio communication network 100, which includes the transmission and reception of such data through both the radio access and core network domains of radio communication network 100. Accordingly, terminal devices 102 and 104 and network access nodes 110 and 120 may follow the defined communication protocols to transmit and receive data over the radio access network domain of radio communication network 100, while the core network may follow the defined communication protocols to route data within and outside of the core network. Exemplary communication protocols include LTE, UMTS, GSM, WiMAX, Bluetooth, Wi-Fi, mmWave, 5G NR, and the like, any of which may be applicable to radio communication network 100.

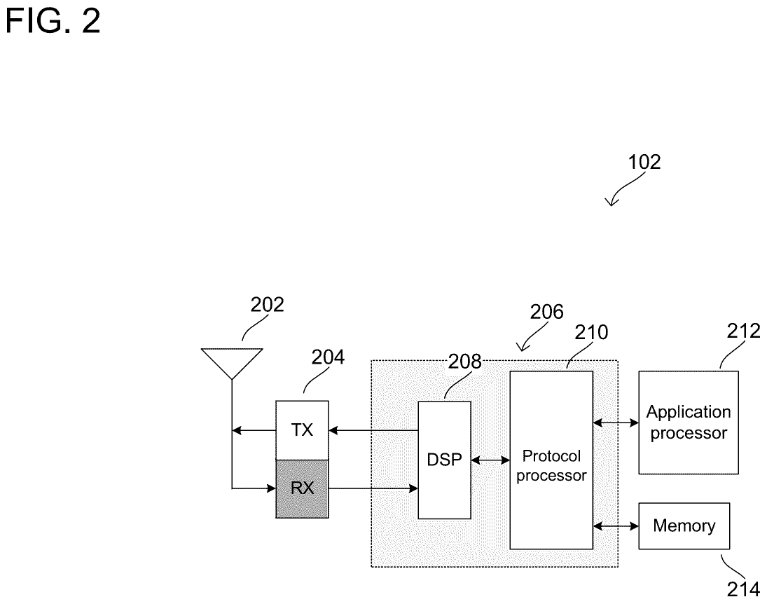

FIG. 2 shows an exemplary internal configuration of terminal device 102, which may include antenna system 202, radio frequency (RF) transceiver 204, baseband modem 206 (including digital signal processor 208 and protocol controller 210), application processor 212, and memory 214. Although not explicitly shown in FIG. 2, terminal device 102 may include one or more additional hardware and/or software components, such as processors/microprocessors, controllers/microcontrollers, other specialty or generic hardware/processors/circuits, peripheral device(s), memory, power supply, external device interface(s), subscriber identity module(s) (SIMs), user input/output devices (display(s), keypad(s), touchscreen(s), speaker(s), external button(s), camera(s), microphone(s), etc.), or other related components.

Terminal device 102 may transmit and receive radio signals on one or more radio access networks. Baseband modem 206 may direct such communication functionality of terminal device 102 according to the communication protocols associated with each radio access network, and may execute control over antenna system 202 and RF transceiver 204 to transmit and receive radio signals according to the formatting and scheduling parameters defined by each communication protocol. Although various practical designs may include separate communication components for each supported radio communication technology (e.g., a separate antenna, RF transceiver, digital signal processor, and controller), for purposes of conciseness the configuration of terminal device 102 shown in FIG. 2 depicts only a single instance of such components.

Terminal device 102 may transmit and receive wireless signals with antenna system 202. Antenna system 202 may be a single antenna or may include one or more antenna arrays that each include multiple antenna elements. For example, antenna system 202 may include an antenna array at the top of terminal device 102 and/or a second antenna array at the bottom of terminal device 102. Antenna system 202 may additionally include analog antenna combination and/or beamforming circuitry. In the receive (RX) path, RF transceiver 204 may receive analog radio frequency signals from antenna system 202 and perform analog and digital RF front-end processing on the analog radio frequency signals to produce digital baseband samples (e.g., In-Phase/Quadrature (IQ) samples) to provide to baseband modem 206. RF transceiver 204 may include analog and digital reception components including amplifiers (e.g., Low Noise Amplifiers (LNAs)), filters, RF demodulators (e.g., RF IQ demodulators)), and analog-to-digital converters (ADCs), which RF transceiver 204 may utilize to convert the received radio frequency signals to digital baseband samples. In the transmit (TX) path, RF transceiver 204 may receive digital baseband samples from baseband modem 206 and perform analog and digital RF front-end processing on the digital baseband samples to produce analog radio frequency signals to provide to antenna system 202 for wireless transmission. RF transceiver 204 may thus include analog and digital transmission components including amplifiers (e.g., Power Amplifiers (PAs), filters, RF modulators (e.g., RF IQ modulators), and digital-to-analog converters (DACs), which RF transceiver 204 may utilize to mix the digital baseband samples received from baseband modem 206 and produce the analog radio frequency signals for wireless transmission by antenna system 202. Baseband modem 206 may control the radio transmission and reception of RF transceiver 204, including specifying the transmit and receive radio frequencies for operation of RF transceiver 204.

As shown in FIG. 2, baseband modem 206 may include digital signal processor 208, which may perform physical layer (PHY, Layer 1) transmission and reception processing to, in the transmit path, prepare outgoing transmit data provided by protocol controller 210 for transmission via RF transceiver 204, and, in the receive path, prepare incoming received data provided by RF transceiver 204 for processing by protocol controller 210. Digital signal processor 208 may be configured to perform one or more of error detection, forward error correction encoding/decoding, channel coding and interleaving, channel modulation/demodulation, physical channel mapping, radio measurement and search, frequency and time synchronization, antenna diversity processing, power control and weighting, rate matching/de-matching, retransmission processing, interference cancelation, and any other physical layer processing functions. Digital signal processor 208 may be structurally realized as hardware components (e.g., as one or more digitally-configured hardware circuits or FPGAs), software-defined components (e.g., one or more processors configured to execute program code defining arithmetic, control, and I/O (input/output) instructions (e.g., software and/or firmware) stored in a non-transitory computer-readable storage medium), or as a combination of hardware and software components. Digital signal processor 208 may include one or more processors configured to retrieve and execute program code that defines control and processing logic for physical layer processing operations. Digital signal processor 208 may execute processing functions with software via the execution of executable instructions. Digital signal processor 208 may include one or more dedicated hardware circuits (e.g., ASICs (Application Specific Integrated Circuits), FPGAs (Field Programmable Gate Arrays), and other hardware) that are digitally configured to specific execute processing functions, where the one or more processors of digital signal processor 208 may offload certain processing tasks to these dedicated hardware circuits, which are known as hardware accelerators. Exemplary hardware accelerators can include Fast Fourier Transform (FFT) circuits and encoder/decoder circuits. The processor and hardware accelerator components of digital signal processor 208 may be realized as a coupled integrated circuit.

Terminal device 102 may be configured to operate according to one or more radio communication technologies. Digital signal processor 208 may be responsible for lower-layer processing functions (e.g., Layer 1/PHY) of the radio communication technologies, while protocol controller 210 may be responsible for upper-layer protocol stack functions (e.g., Data Link Layer/Layer 2 and/or Network Layer/Layer 3). Protocol controller 210 may thus be responsible for controlling the radio communication components of terminal device 102 (antenna system 202, RF transceiver 204, and digital signal processor 208) in accordance with the communication protocols of each supported radio communication technology, and accordingly may represent the Access Stratum and Non-Access Stratum (NAS) (also encompassing Layer 2 and Layer 3) of each supported radio communication technology. Protocol controller 210 may be structurally embodied as a communication protocol processor configured to execute protocol stack software (retrieved from a controller memory) and subsequently control the radio communication components of terminal device 102 to transmit and receive communication signals in accordance with the corresponding communication protocol stack control logic defined in the protocol software. Protocol controller 210 may include one or more processors configured to retrieve and execute program code that defines the upper-layer protocol stack logic for one or more radio communication technologies, which can include Data Link Layer/Layer 2 and Network Layer/Layer 3 functions. Protocol controller 210 may be configured to perform both user-plane and control-plane functions to facilitate the transfer of application layer data to and from radio terminal device 102 according to the specific communication protocols of the supported radio communication technology. User-plane functions can include header compression and encapsulation, security, error checking and correction, channel multiplexing, scheduling and priority, while control-plane functions may include setup and maintenance of radio bearers. The program code retrieved and executed by protocol controller 210 may include executable instructions that define the logic of such functions.

Terminal device 102 may also include application processor 212 and memory 214. Application processor 212 may be a CPU, and may be configured to handle the layers above the communication protocol stack, including the transport and application layers. Application processor 212 may be configured to execute various applications and/or programs of terminal device 102 at an application layer of terminal device 102, such as an operating system (OS), a user interface (UI) for supporting user interaction with terminal device 102, and/or various user applications. The application processor may interface with baseband modem 206 and act as a source (in the transmit path) and a sink (in the receive path) for user data, such as voice data, audio/video/image data, messaging data, application data, basic Internet/web access data, etc. In the transmit path, protocol controller 210 may therefore receive and process outgoing data provided by application processor 212 according to the layer-specific functions of the protocol stack, and provide the resulting data to digital signal processor 208. Digital signal processor 208 may then perform physical layer processing on the received data to produce digital baseband samples, which digital signal processor may provide to RF transceiver 204. RF transceiver 204 may then process the digital baseband samples to convert the digital baseband samples to analog RF signals, which RF transceiver 204 may wirelessly transmit via antenna system 202. In the receive path, RF transceiver 204 may receive analog RF signals from antenna system 202 and process the analog RF signals to obtain digital baseband samples. RF transceiver 204 may provide the digital baseband samples to digital signal processor 208, which may perform physical layer processing on the digital baseband samples. Digital signal processor 208 may then provide the resulting data to protocol controller 210, which may process the resulting data according to the layer-specific functions of the protocol stack and provide the resulting incoming data to application processor 212. Application processor 212 may then handle the incoming data at the application layer, which can include execution of one or more application programs with the data and/or presentation of the data to a user via a user interface.

Memory 214 may be a memory component of terminal device 102, such as a hard drive or another such permanent memory device. Although not explicitly depicted in FIG. 2, the various other components of terminal device 102 shown in FIG. 2 may additionally each include integrated permanent and non-permanent memory components, such as for storing software program code, buffering data, etc.

In accordance with some radio communication networks, terminal devices 102 and 104 may execute mobility procedures to connect to, disconnect from, and switch between available network access nodes of the radio access network of radio communication network 100. As each network access node of radio communication network 100 may have a specific coverage area, terminal devices 102 and 104 may be configured to select and re-select available network access nodes in order to maintain a strong radio access connection with the radio access network of radio communication network 100. For example, terminal device 102 may establish a radio access connection with network access node 110 while terminal device 104 may establish a radio access connection with network access node 112. If the current radio access connection degrades, terminal devices 102 or 104 may seek a new radio access connection with another network access node of radio communication network 100; for example, terminal device 104 may move from the coverage area of network access node 112 into the coverage area of network access node 110. As a result, the radio access connection with network access node 112 may degrade, which terminal device 104 may detect via radio measurements such as signal strength or signal quality measurements of network access node 112. Depending on the mobility procedures defined in the appropriate network protocols for radio communication network 100, terminal device 104 may seek a new radio access connection (which may be, for example, triggered at terminal device 104 or by the radio access network), such as by performing radio measurements on neighboring network access nodes to determine whether any neighboring network access nodes can provide a suitable radio access connection. As terminal device 104 may have moved into the coverage area of network access node 110, terminal device 104 may identify network access node 110 (which may be selected by terminal device 104 or selected by the radio access network) and transfer to a new radio access connection with network access node 110. Such mobility procedures, including radio measurements, cell selection/reselection, and handover are established in the various network communication protocols and may be employed by terminal devices and the radio access network in order to maintain strong radio access communication connections between each terminal device and the radio access network across any number of different radio access network scenarios.

A static quantization scheme for a particular RRM algorithm may not be optimal depending on the RAN environment with regard to time and the number of cells. The static quantization scheme for an RRM algorithm may not adjust quantization based on varying RAN performance or environmental variables during RAN operation.

Because statically quantized data for AI/ML models do not take into account the varying cell environment of the RAN, they fail to reduce RRM algorithm computation and latency. Moreover, the static scheme could lead to unnecessary performance degradation when the static quantization of input data for an AI/ML model does not work well for at different times and number of cells of a RAN environment.

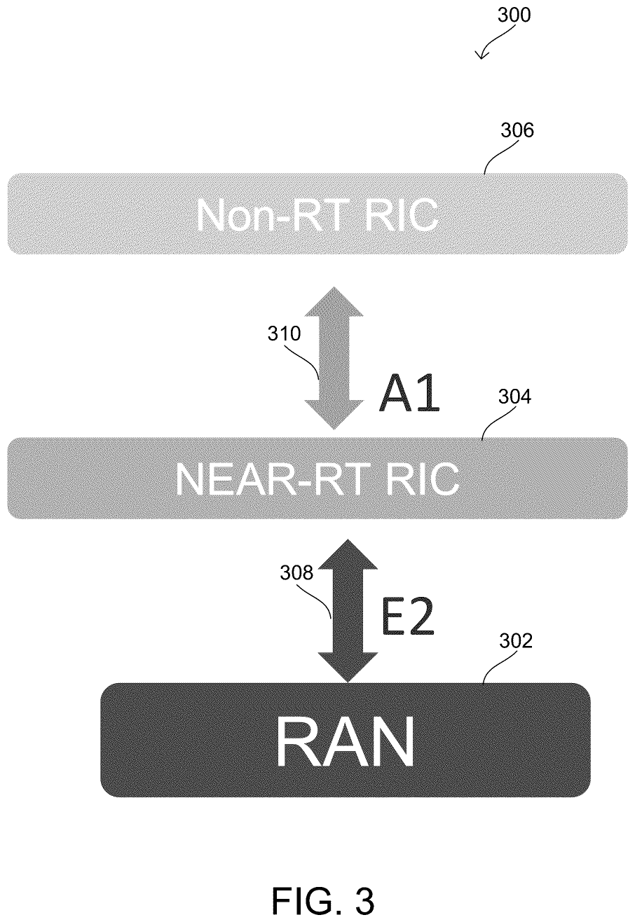

FIG. 3 shows a block diagram of a distributed DRQM 300 for reducing computation complexity and power consumption of AI/ML models for an RRM algorithm in RAN 302. RRM algorithm logic can be pushed partly or fully to Near-Real Time (RT) RIC 304 or Non-RT RIC 306. The two RICs 304 and 306 may be differentiated by processing time. For example, the Near-RT RIC may process a functionality must performed in less than 10 μs. The Non-RT RIC may process a functionality which may take longer than 10 μs, assuming a latency deadline is met. The decision to distribute RAM algorithms may be based on historical data of correct predictions for a RAN environment. Low latency logic can be mapped to Near-RT RIC 304 over E2 interface 308 and longer latency logic can be mapped to Non-RT RIC 306 over AI interface 310. E2 interface 308 may connect Near-RT RIC 304 to an open central unit (O-CU), open distributed unit (O-DU), or open evolved nodeB (O-eNB), or other elements of RAN 302. A1 interface 310 may connect two O-RAN specific components such as Near-RT RIC 304 to Non-RT RIC 306.

A dynamic RAN quantization module (DRQM) may identify an optimal quantization scheme for each cell in a RAN based on the dynamic cell environment at a given point in time. The optimal quantization scheme may reduce power consumption and improve performance by opportunistically taking advantage of changes in the RAN environment. The DRQM may be called by multiple RRM algorithms and can be implemented on a controller platform. Implementing the DRQM on the controller platform, such as RIC 304 and RIC 306, may reduce the data and memory overhead. Note that the DRQM may be implemented in conjunction with different AI/ML techniques used in different RRM algorithms. For example, the DRQM may function per RAN cell and be part with centralized learning and distributed learning environments AI/ML models. Regardless of the training methods of the RRM models, the DRQM may determine a quantization scheme which satisfies RAN performance requirements and minimizes computation and memory requirements. Different AI/ML algorithms may require different levels of granularity of input data. For example, a load prediction may require the quantized input data at a higher level of granularity than a throughput prediction algorithm or an energy saving prediction algorithm, etc.

AI/ML based RRM algorithm computations for a RAN may be hosted on a controller platform. For example, a controller platform may be a RAN intelligent controller (RIC), Intelligent Edge, or a controller residing within the RAN itself such as in the eNB/gNB. The controller platform may also host training and inference servers. Because multiple AI/ML models for different RRM algorithms for a cell or groups of cells may reside on the controller platform, the AI/ML models may have constrained computation and memory capabilities. Quantization of input data for AI/ML algorithms may alleviate the computation and storage restrictions of a controller platform. Quantizing input data may save memory storage requirements for AI/ML models. For example, quantization may reduce the storage requirement by up to 400 percent and achieve a reduction in latency by up to four times. Quantization reduces the input data by producing a smaller representation of the input data while maintaining RAN performance. The reduced representation of input data may allow multi-layered transformer models of the RRM algorithm to achieve performance improvements in the RAN as compared to models without quantization. The reduction in memory storage requirements may also enable the use of more complex models which offer more accurate predictions or inferences. The more complex models would normally require more memory. However, quantization may allow more complex models to operate on less memory than the same complex model would require without quantization.

Several characteristics of a RAN environment may vary over time and space. The space may represent the number of cells of a RAN. For example, cell traffic volume, cell Physical Resource Block (PRB) usage, the number of users, performance indicators, etc. may vary over time and number of cells. Examples, of RAN performance indicators may include cell throughput, user throughput, user spectral efficiency, latency, etc. A DRQM may use data representing the RAN environment as input for determining an optimal quantization scheme. For example, in a particular cell the PRB usage load varies according to the time of day and across multiple cells based on the geo-location. During most of the day the PRB usage load may be categorized as low. During times of peak traffic, PRB usage load may be categorized as high. For example, a low PRB usage load could 30% or less and high PRB usage load could be 70% or more. Similarly, load may depend on a cell's physical location. For example, cells near a stadium during an event may be associated with high PRB usage load. In contrast, the cells in a rural region may be associated with low PRB usage load. Based on the dynamic characteristics of input data from a RAN, it would be advantageous to dynamically select a quantization scheme for an RRM algorithm based on the RAN environment data. An AI/ML, based RRM algorithm's performance may benefit from the dynamically selected quantization scheme. Leveraging the changes in the RAN environment to select a more optimal quantization scheme may reduce latency and algorithm computation complexity.

The DRQM may identify a quantization scheme for various AI/ML models of an RRM algorithm at different times of the day for multiple cells. The identified quantization scheme may improve performance over using a static quantization scheme for all AI/ML models. The identified quantization scheme may save computation costs and improve latency as compared to a static quantization scheme. The identified quantization scheme may produce low bit data to represent the current cell conditions of a RAN, as compared to the static quantization scheme, and improve RAN performance. For example, low bit quantization may improve latency of a deep learning model, such as a transformer, by up to 4 times. Improvements in transformer latency may improve the performance of a RAN in which a identified quantization scheme is an improvement over the static quantization scheme given the current cell conditions of a RAN. For example, when an RRM algorithm of the RAN may require more bits than the static dynamic scheme is capable of providing.

Members of an O-RAN may run a DRQM as an xApp or rApp product for any 0-RAN reference architecture. An xApp or rApp may be software developed to run on a RIC and control or optimize RAN functions. For example, the DRQM may be software according to xAPP standards and configured to run on a Near-RT RIC of the O-RAN. Alternatively, the DRQM may be software according to rApp standards and configured to run on a non-RT RIC of the O-RAN. The DRQM may be incorporated into the O-RAN standards and serve multiple use-cases. The quantization scheme for input data for AI/ML models may be based on the AI/ML model prediction performance. For example, mean square error, mean absolute error, etc. Additionally, quantization of input data for AI/ML models may be further based on the AI/ML, model's memory requirements and computation complexity requirements. Aspects to consider when designing an AI/ML quantization scheme may include RAN performance and dynamic cell characteristics of RAN data.

In the context of a RAN, performance may be a function of specific key metrics of the RAN. For example, throughput, latency, call drops, power consumption etc. Therefore, the performance of a quantized AI/ML model may be based on the key metrics of the RAN in addition to the accuracy of quantized model. Each key metric may be weighted differently per cell of the RAN.

RAN performance may be represented by the following equation:

f(T,P,q)=g(T,q)+k*h(P,q)

where f is performance, T denotes throughput or quality of service and g is the corresponding functional form, P is power saved and h is corresponding functional form, and q is the quantization that would need to be determined, k represents different weights for prioritizing the performance vs power saving and/or latency, k may represent other prioritized weights such as dropped calls.

In an O-RAN with thousands of cells, different subsets of the thousands of cells may have different functional forms based on the requirements and locations of each subset of cells. For example, a subset of cells of an O-RAN operator may weigh power saving higher than in another subset of cells when determining O-RAN performance. In contrast, another subset of cells of an O-RAN may weigh dropped calls higher than in another subset of cells when determining O-RAN performance. As a result, a DRQM may select different quantization schemes for different subset of cells based on each subsets RAN performance equation.

AI/ML model based RRM algorithms for a RAN may be trained on data collected from single or multiple cells. For example, training an AI/ML model may occur offline before it is deployed in the O-RAN. Alternatively, training an AI/ML model may occur with offline data on a Non-RT RIC. The AI/ML models may take multiple data inputs to generate a prediction. Additionally, a plurality of AI/ML models, such as a chained model, may combine predictions to determine a final prediction. The collected data of the RAN may be dynamic. Multiple characteristics of the RAN may change according to different time of the days, days of the week, location, etc. For example, the input data for an AI/ML model may include the number of active users, the number of active baseband units, etc. The changing characteristics may offer the possibility of saving computations when the input data requires lower bit quantization.

An exemplary RRM algorithm may be configured for power saving and include a traffic prediction model. The AI/ML traffic prediction model of the power saving RRM algorithm may include a downlink (DL) PRB usage prediction model which predict the future load given input data to the model. The input data may include the past 100 samples of DL PRB usage for one or more cells. The input data may also include past 100 samples of a number of RRC connected users, a time of the day, weather, special event pattern in the cell, first and second order moments of DL PRB usage, etc. The AI model may be a Multi-Layer perception neural network with 5 or 6 layers and an order of hundreds of inputs.

The time and number of cells of a RAN may affect the RAN data characteristics. For example, cell traffic, cell PRB usage, number of users, etc., may vary dependent on time and the number of cells. These variations may also vary from cell to cell. For example, the usage load of a particular cell may vary with the time of the day while the usage load may remain constant for another cell. Therefore, the characteristics of RAN data for the particular cell may vary with time of the day, and across multiple cells based on the location. As a result, the desired quantization scheme for the particular cell at night might be different than the desired quantization scheme for the other cell. However, both the particular cell and the other cell may have the same desired quantization scheme during the day.

Selecting the quantization scheme for input data of the AI/ML models in an RRM algorithm of a RAN may depend on the changing cell characteristics. For example, if there are fewer active users in RAN, a lower bit quantization scheme may work well for generating accurate predictions. The lower bit quantization scheme may reduce the computation complexity of the AI/ML model and improve overall performance. As cell characteristics of the RAN change, the quantization of input data into the AI/ML models may change to improve performance. For example, reduce power consumption and computations. The quantization scheme may have to be recalibrated and updated with time as the RAN data changes. The recalibration of the quantization scheme may differ for different cells of a RAN.

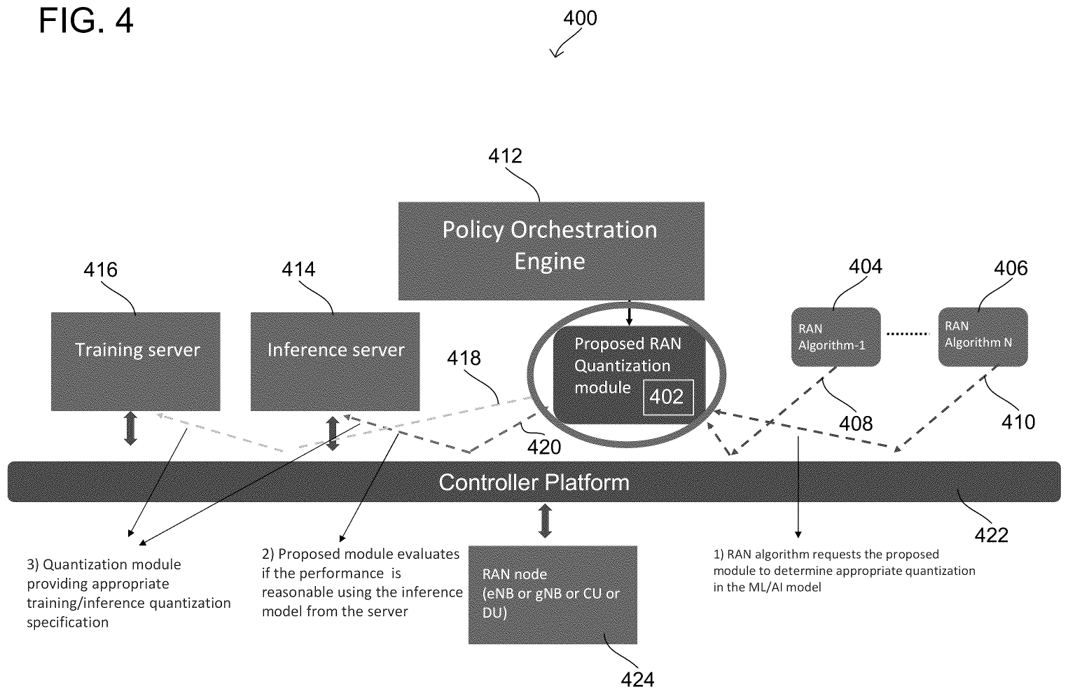

FIG. 4 shows how a DRQM 402 may operate within a RAN system 400. To select the quantization scheme for input data of the AI/ML models, RRM algorithms 404 and 406 may identify the DRQM 402. DRQM 402 may include an identification API to interface with RRM algorithms 404 and 406. The DRQM may receive requests 408 and 410 from RRM algorithms 404 and 406 respectively to select the quantization scheme for the input data of the AI/ML models based on RAN data. The DRQM may receive requests 408 and 410 through a DRQM API. The DRQM API may include the identification API or they may be separate. The DRQM API may be configured to receive messages 408 and 410 from RRM algorithms. The DRQM may receive RAN operator preferences from policy orchestration engine 412 to use as input in selecting the quantization scheme. DRQM 402 may include a policy API to interface with policy orchestration engine 412. The operator preferences may include a list of priority cells where DRQM can be used, criteria such as thresholds for minimum performance of the quantization schemes, a list of RRM algorithms for dynamic quantization scheme selection, etc. Policy orchestration engine 412 may also include weighting of computation savings vs performance for each of the cells in the RAN as part of operator preferences. The weighting may correspond to the k parameter described earlier with respect to the performance equation. A RAN operator remains in control of where and how the DRQM is used through policy orchestration engine 412.

A message from RRM algorithms 404 and 406 to DRQM 402 may include input features, minimum performance requirements of the RRM algorithm, throughput latency, past performance of an algorithm, model parameters and architecture of the RRM algorithm, error statistics of prediction, an objective function of RAN performance as compared to power consumed, hardware resource requirements, a set of quantization configurations, and a quantization update period. The input features may include DL PRB usage, number of RAN users, incident traffic, etc. for a cell environment. The past performance of the algorithm may be in terms of RAN key performance indicators (KPIs) such as throughput, latency, etc. The error statistics may include a histogram of predictions accuracy. All this information included in messages 404 and 406 may affect the determination of a quantization scheme. For example, if the information includes high levels of data and all of it is needed to generate an accurate prediction, the quantization scheme may be very granular to ensure that all the data is represented.

The DRQM may calculate the current quantization scheme performance of the RRM algorithms 408 and 410 to determine if they meet minimum requirements of the performance of the RAN. For example 5G ultra reliable low latency communications (URLLC) traffic may have an end to end latency requirement of 5 ms. As another example, minimum power saving requirements may be a 20% savings. Other examples of minimum requirements may include quality of service (QOS) degradation due to power saving of less than 0.1%. Other minimum requirement metrics may be defined. DRQM 402 may evaluate quantization scheme performance using inference server 414 for a proposed quantization scheme. DRQM may propose an updated quantization scheme through message 420 to inference server 414. The DRQM may further determine the best quantization scheme for the AI/ML model by evaluating the quantization scheme with training server 416. DRQM 402 may send specifications 418 to training server 416 to evaluate the selected quantization scheme to determine if it is able to maximize the long term objective of minimizing computations and power consumption while meeting RAN performance requirements. Communications 408, 410, 418, and 420 may be done through controller platform 422. This allows for a distributed environment where each component may reside in separate locations. Alternatively, some or all components may reside on a base station such as RAN node 424. RAN node 424 may provide controller platform 422 with input data for evaluating the quantization scheme.

Once DRQM 402 selects the optimal quantization, DRQM 402 notifies RRM algorithms 406 and 408 via a DRQM API of the selected quantization scheme. The notification may include a quantization bit-width of the selected quantization scheme for a particular cell or group of cells.

The DRQM may update the quantization scheme in a periodic fashion. For example, every 15 minutes. Alternatively, the DRQM may update the quantization scheme based on a performance threshold of the AI/IL model. The performance threshold or criteria may include preferences for one or more cells such as thresholds for minimum performance of the AI/ML models, RRM algorithms for which the DRQM applies, weightage of computation saving vs performance degradation for the corresponding cells. The updated quantization scheme may have an updated mapping from the input data to a discrete representation of the data. The more granular the mapping of input data to the representation set, the more accurate a prediction may be. However, this may come with computation and memory costs. The granularity of the quantization scheme may be reduced to make the representation set smaller. The smaller representation set, may make the predictions less accurate. However, if the RAN does not suffer from reduced performance, the less accurate predictions may be an acceptable trade-off to the high computation and memory requirements of very granular quantization schemes. RAN performance may have to meet certain criterion. The updated quantization scheme may satisfy RAN performance criterion while reducing computation and memory requirements. Alternatively, if RAN performance may fall, the updated quantization scheme may be more granular to satisfy RAN performance criterion at the cost of higher computation and memory requirements. The DRQM algorithm may dynamically determine a quantization scheme to meet minimum RAN performance requirements while reducing power consumption, calculation complexity, and/or memory requirements, etc.

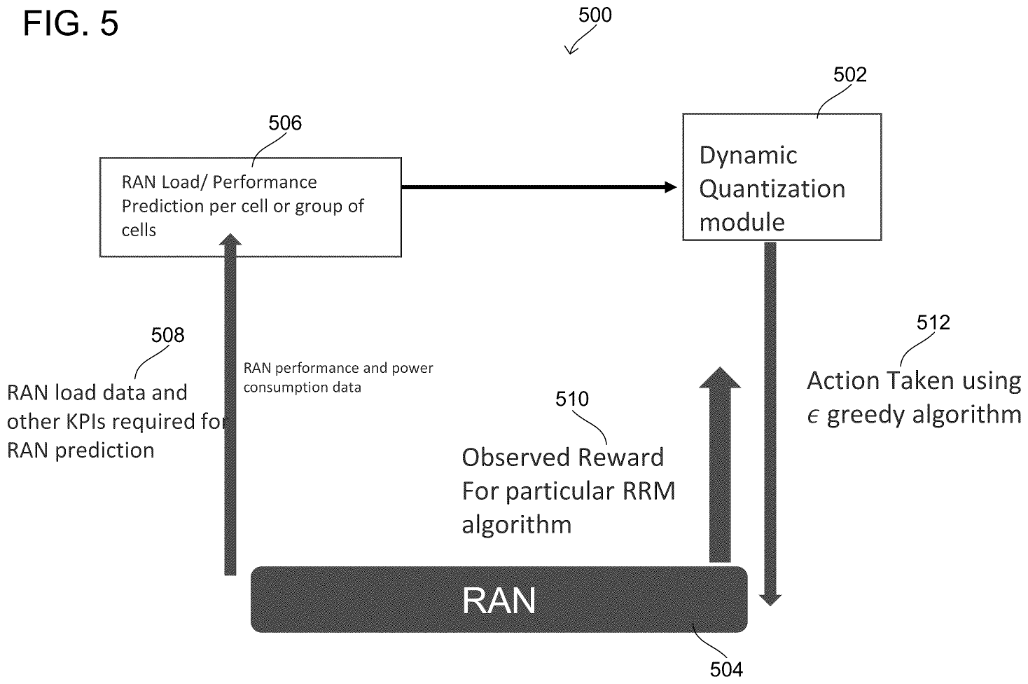

FIG. 5 shows a block diagram of an algorithm 500 for dynamic quantization for a RAN. The DRQM 502 may follow a reinforced learning (RL) approach to determine a quantization scheme. Please note that the DRQM 502 may use other model-based or model-free approaches to reinforcement learning to determine a quantization scheme. Reinforcement learning may attempt to maximize reward in a particular situation. It is employed by various software and machines to find the best possible behavior or path it should take in a specific situation. The RL based approach may determine the optimal bit-width of the quantization scheme from an action set. For example, the action set may include different quantization bit-widths as shown in the action set below:
{2 bit, 4 bit, 8 bit, 12 bit, 16 bit, 32 bit}.

Algorithm 500 may take determine a RAN 504 state using several parameters. For example, the state S may be defined by parameters 508 of a cell environment. An equation may determine the state of a cell of a RAN. State is defined by the cell environment at point in time t given several parameters. For example, the parameters may include the number of users, average signal-to-noise ratio, physical resource block load, and average UE speed and/or mobility.

The results or reward of the updated quantization scheme may be given by the following equation:

(S(t),A)=f(T,P,q)=g(T,q)+k*h(P,q)

where f is performance, T (S,A) is throughput and g is its corresponding functional form, P (S,A) is the power saved and h is its corresponding functional form, and q is the quantization that is determined by the DRQM 502. K represents different weights for different metrics. Note that the result may be specific for each RRM algorithm. DRQM 502 may evaluate the performance prediction 506 to determine if an updated quantization scheme may improve RAN performance.

Additionally, DRQM 502 may implement further RL algorithms to learn the long term reward the DRQM 502 achieves with an updated quantization scheme. For example, a Q learning algorithm 512 may determine the observed reward 510 for a particular RRM. The long-term reward represented by Q(S,A) may determine an action A (quantization) to maximize the reward of the Q function using a greedy algorithm.

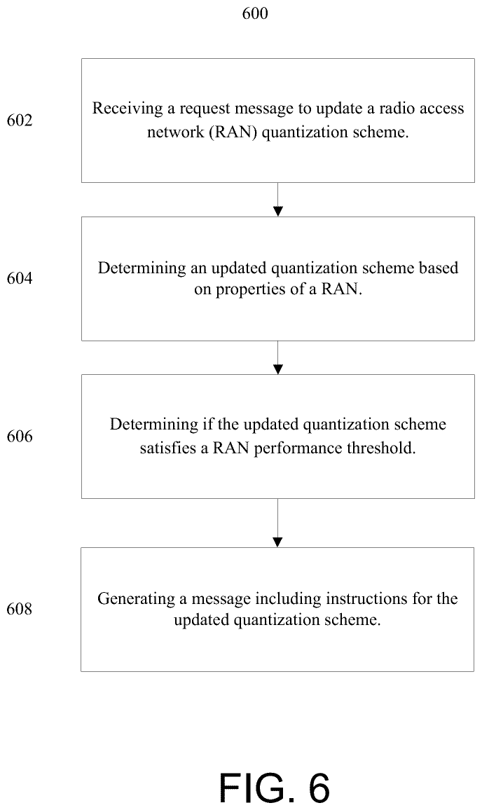

FIG. 6 shows exemplary method 600 of estimating a wireless communication device trajectory. As shown in FIG. 6, method 600 includes receiving a request message to update a radio access network (RAN) quantization scheme (stage 602), determining an updated quantization scheme based on properties of a RAN (stage 604), determining if the updated quantization scheme satisfies a RAN performance criterion (stage 606), and generating a message including instructions for the updated quantization scheme (stage 608).

While the above descriptions and connected figures may depict electronic device components as separate elements, skilled persons will appreciate the various possibilities to combine or integrate discrete elements into a single element. Such may include combining two or more circuits for form a single circuit, mounting two or more circuits onto a common chip or chassis to form an integrated element, executing discrete software components on a common processor core, etc. Conversely, skilled persons will recognize the possibility to separate a single element into two or more discrete elements, such as splitting a single circuit into two or more separate circuits, separating a chip or chassis into discrete elements originally provided thereon, separating a software component into two or more sections and executing each on a separate processor core, etc.

It is appreciated that implementations of methods detailed herein are demonstrative in nature, and are thus understood as capable of being implemented in a corresponding device. Likewise, it is appreciated that implementations of devices detailed herein are understood as capable of being implemented as a corresponding method. It is thus understood that a device corresponding to a method detailed herein may include one or more components configured to perform each aspect of the related method.

All acronyms defined in the above description additionally hold in all claims included herein.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The terms “group,” “set”, “sequence,” and the like refer to a quantity equal to or greater than one.

Any term expressed in plural form that does not expressly state “plurality” or “multiple” similarly refers to a quantity equal to or greater than one.

The term “lesser subset” refers to a subset of a set that contains less than all elements of the set.

Any vector and/or matrix notation utilized herein is exemplary in nature and is employed for purposes of explanation. This disclosure may be described with vector and/or matrix notation are not limited to being implemented with vectors and/or matrices and the associated processes and computations may be performed in an equivalent manner with sets or sequences of data or other information.

The words “exemplary” and “demonstrative” are used herein to mean “serving as an example, instance, demonstration, or illustration”. Any aspect, embodiment, or design described herein as “exemplary” or “demonstrative” is not necessarily to be construed as preferred or advantageous over other aspects, embodiments, or designs.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of with regard to a group of elements may be used herein to mean at least one element from the group consisting of the elements. For example, the phrase “at least one of with regard to a group of elements may be used herein to mean one of the listed elements, a plurality of one of the listed elements, a plurality of individual listed elements, or a plurality of a multiple of individual listed elements.

The term “data” as used herein may be understood to include information in any suitable analog or digital form, e.g., provided as a file, a portion of a file, a set of files, a signal or stream, a portion of a signal or stream, a set of signals or streams, and the like. Further, the term “data” may also be used to mean a reference to information, e.g., in form of a pointer. The term “data”, however, is not limited to the aforementioned examples and may take various forms and/or may represent any information as understood in the art.

The terms “processor” or “controller” may be understood to include any kind of technological entity that allows handling of any suitable type of data and/or information. The data and/or information may be handled according to one or more specific functions executed by the processor or controller. Further, a processor or a controller may be understood as any kind of circuit, e.g., any kind of analog or digital circuit. A processor or a controller may thus be or include an analog circuit, digital circuit, mixed-signal circuit, logic circuit, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” is understood as a computer-readable medium (e.g., a non-transitory computer-readable medium) in which data or information can be stored for retrieval. References to “memory” may thus be understood as referring to volatile or non-volatile memory, including random access memory (RAM), read-only memory (ROM), flash memory, solid-state storage, magnetic tape, hard disk drive, optical drive, among others, or any combination thereof. Registers, shift registers, processor registers, data buffers, among others, are also embraced herein by the term memory. The term “software” may be used to refer to any type of executable instruction and/or logic, including firmware.

The term “terminal device” utilized herein refers to user-side devices (both portable and fixed) that can connect to a core network and/or external data networks via a radio access network. “Terminal device” can include any mobile or immobile wireless communication device, including User Equipments (UEs), Mobile Stations (MSs), Stations (STAs), cellular phones, tablets, laptops, personal computers, wearables, multimedia playback and other handheld or body-mounted electronic devices, consumer/home/office/commercial appliances, vehicles, and any other electronic device capable of user-side wireless communications.

The term “network access node” as utilized herein refers to a network-side device that provides a radio access network with which terminal devices can connect and exchange information with a core network and/or external data networks through the network access node. “Network access nodes” can include any type of base station or access point, including macro base stations, micro base stations, NodeBs, evolved NodeBs (eNBs), gNodeBs, Home base stations, Remote Radio Heads (RRHs), relay points, Wi-Fi/WLAN Access Points (APs), Bluetooth master devices, DSRC RSUs, terminal devices acting as network access nodes, and any other electronic device capable of network-side wireless communications, including both immobile and mobile devices (e.g., vehicular network access nodes, moving cells, and other movable network access nodes). As used herein, a “cell” in the context of telecommunications may be understood as a sector served by a network access node. Accordingly, a cell may be a set of geographically co-located antennas that correspond to a particular sectorization of a network access node. A network access node can thus serve one or more cells (or sectors), where the cells are characterized by distinct communication channels.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. The circuitry may be implemented in, or functions associated with the circuitry may be implemented by, one or more software or firmware modules. Circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and/or the like. Logic may be executed by one or more processors using memory, e.g., registers, buffers, stacks, and the like, coupled to the one or more processors, e.g., as necessary to execute the logic.

The terms “communicate” and “communicating” as used herein with respect to a signal includes transmitting the signal and/or receiving the signal. For example, an apparatus, which is capable of communicating a signal, may include a transmitter to transmit the signal, and/or a receiver to receive the signal. The verb communicating may be used to refer to the action of transmitting or the action of receiving. In one example, the phrase “communicating a signal” may refer to the action of transmitting the signal by a transmitter, and may not necessarily include the action of receiving the signal by a receiver. In another example, the phrase “communicating a signal” may refer to the action of receiving the signal by a receiver, and may not necessarily include the action of transmitting the signal by a transmitter.

The term “antenna”, as used herein, may include any suitable configuration, structure and/or arrangement of one or more antenna elements, components, units, assemblies and/or arrays. The antenna may implement transmit and receive functionalities using separate transmit and receive antenna elements. The antenna may implement transmit and receive functionalities using common and/or integrated transmit/receive elements. The antenna may include, for example, a phased array antenna, a single element antenna, a set of switched beam antennas, and/or the like. In one example, an antenna may be implemented as a separate element or an integrated element, for example, as an on-module antenna, an on-chip antenna, or according to any other antenna architecture.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.1 lay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V2I) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Examples described herein can be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme can be used on a secondary basis on bands such as the TV White Space bands (typically below 790 MHz) where e.g. the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

Examples described herein can also implement a hierarchical application of the scheme, e.g. by introducing a hierarchical prioritization of usage for different types of users (e.g., low/medium/high priority, etc.), based on a prioritized access to the spectrum e.g. with highest priority to tier-1 users, followed by tier-2, then tier-3, etc. users, etc.

Some of the features in this document are defined for the network side, such as Access Points, eNodeBs, New Radio (NR) or next generation Node Bs (gNodeB or gNB—note that this term is typically used in the context of 3GPP fifth generation (5G) communication systems), etc. Still, a User Equipment (UE) may take this role as well and act as an Access Points, eNodeBs, gNodeBs, etc. i.e., some or all features defined for network equipment may be implemented by a UE.

Some examples may be used in conjunction with Radio Frequency (RF) systems, radar systems, vehicular radar systems, autonomous systems, robotic systems, detection systems, InfraRed (IR) systems, or the like. For example, with respect to systems, e.g., Light Detection Ranging (LiDAR) systems, and/or sonar systems, utilizing light and/or acoustic signals.

This disclosure may be used in conjunction with various devices and systems, for example, a radar sensor, a radar device, a radar system, a vehicle, a vehicular system, an autonomous vehicular system, a vehicular communication system, a vehicular device, an airborne platform, a waterborne platform, road infrastructure, sports-capture infrastructure, city monitoring infrastructure, static infrastructure platforms, indoor platforms, moving platforms, robot platforms, industrial platforms, a sensor device, a User Equipment (UE), a Mobile Device (MD), a wireless station (STA), a sensor device, a non-vehicular device, a mobile or portable device, and the like.

The following examples disclose various aspects of this disclosure:

In Example 1, a wireless communication device including a memory configured to store instructions; a processor coupled to the memory configured to execute the instructions stored on the memory, wherein the instructions are configured to: receive a request message to update a radio access network (RAN) quantization scheme; determine an updated quantization scheme based on properties of a RAN; determine if the updated quantization scheme satisfies a RAN performance threshold or criterion; and generate a message including instructions for the updated quantization scheme.

In Example 2, a wireless communication device including a processor configured to: receive a request message to update a radio access network (RAN) quantization scheme; determine an updated quantization scheme based on properties of a RAN; determine if the updated quantization scheme satisfies a RAN performance threshold; and generate a message including instructions for the updated quantization scheme.

In Example 3, a wireless communication device including a first circuit configured to receive a request message to update a radio access network (RAN) quantization scheme; a second circuit configured to determine an updated quantization scheme based on properties of a RAN; a third circuit configured to determine if the updated quantization scheme satisfies a RAN performance threshold; and a fourth circuit configured to generate a message including instructions for the updated quantization scheme.

In Example 4, the subject matter of any of Examples 1 to 3 may optionally further include, wherein the request message is sent by a radio resource management (RRM) algorithm.

In Example 5, the subject matter of any of Examples 1 to 4 may optionally further include, wherein the request message is sent in response to a change in RAN properties.

In Example 6, the subject matter of any of Examples 1 to 5 may optionally further include, wherein the request message is sent at a time interval.

In Example 7, the subject matter of any of Examples 1 to 6 may optionally further include, wherein the RRM algorithm is a load prediction algorithm.

In Example 8, the subject matter of any of Examples 1 to 7 may optionally further include, wherein the RRM algorithm is a spectral efficiency prediction algorithm.

In Example 9, the subject matter of any of Examples 1 to 8 may optionally further include, wherein the RRM algorithm is a traffic prediction algorithm.

In Example 10, the subject matter of any of Examples 1 to 9 may optionally further include, wherein the instructions are part of a RAN intelligent controller (RIC).

In Example 11, the subject matter of any of Examples 1 to 10 may optionally further include, wherein the RIC is a near-real time RIC.

In Example 12, the subject matter of any of Examples 1 to 11 may optionally further include, wherein the RIC is a non-real time RIC.

In Example 13, the subject matter of any of Examples 1 to 12 may optionally further include, wherein the updated quantization scheme includes more bits than the RAN quantization scheme.

In Example 14, the subject matter of any of Examples 1 to 13 may optionally further include, wherein the updated quantization scheme includes less bits than the RAN quantization scheme.

In Example 15, the subject matter of any of Examples 1 to 14 may optionally further include, wherein the updated quantization scheme reduces a storage requirement of the RRM.

In Example 16, the subject matter of any of Examples 1 to 15 may optionally further include, wherein the updated quantization scheme reduces a computation requirement of the RRM.

In Example 17, the subject matter of any of Examples 1 to 16 may optionally further include, wherein the reduced computation requirement reduces a time to generate a prediction.

In Example 18, the subject matter of any of Examples 1 to 17 may optionally further include, wherein the memory and the processor are part of a base station.

In Example 19, the subject matter of any of Examples 1 to 18 may optionally further include, wherein the RRM is configured to determine a change in RAN properties.

In Example 20, the subject matter of any of Examples 1 to 19 may optionally further include, wherein the processor is further configured to determine the updated quantization scheme based on RAN operator preferences.

In Example 21, the subject matter of any of Examples 1 to 20 may optionally further include, wherein the processor is further configured to: obtain the RAN performance criterion; determine a performance of the updated quantization scheme; compare the performance of the updated quantization scheme with the RAN performance criterion to determine if the updated quantization scheme satisfies the RAN performance criterion.

In Example 22, the subject matter of any of Examples 1 to 21 may optionally further include, wherein the RAN properties are based on a learned pattern of the RAN.

In Example 23, the subject matter of any of Examples 1 to 22 may optionally further include, wherein the learned pattern of the RAN is based on a time of day.

In Example 24, the subject matter of any of Examples 1 to 23 may optionally further include, wherein the learned pattern of the RAN is based on a location of one or more cells of the RAN.

In Example 25, the subject matter of any of Examples 1 to 24 may optionally further include, wherein the updated quantization scheme minimizes the computation requirement of the RRM algorithm.

In Example 26, the subject matter of any of Examples 1 to 25 may optionally further include, wherein the updated quantization scheme minimizes the memory requirement of the RRM algorithm.

In Example 27, the subject matter of any of Examples 1 to 26 may optionally further include, wherein the processor is further configured send the message to the RRM algorithm.

In Example 28, the subject matter of any of Examples 1 to 27 may optionally further include, wherein the updated quantization scheme is associated with a cell or group of cells of the RAN.

In Example 29, the subject matter of any of Examples 1 to 28 may optionally further include, wherein the updated quantization scheme includes a bit width.

In Example 30, the subject matter of any of Examples 1 to 29 may optionally further include, wherein the bit width is selected from a set of bit widths.

In Example 31, the subject matter of any of Examples 1 to 30 may optionally further include, wherein the processor is further configured to determine an improvement metric for the RRM.

In Example 32, the subject matter of any of Examples 1 to 31 may optionally further include, wherein the improvement metric is associated with a bit width of the updated quantization scheme.

In Example 33, the subject matter of any of Examples 1 to 32 may optionally be further configured to receive the request message from a radio resource management (RRM) algorithm.

In Example 34, the subject matter of any of Examples 1 to 33 may optionally further include, wherein the request message includes one or more input parameters of the RRM algorithm, wherein the input parameters are associated with a mobile radio cell of the RAN.

In Example 35, the subject matter of any of Examples 1 to 34 may optionally further include, wherein the one or more input parameters includes a downlink (DL) physical resource block (PRB) utilization metric of the mobile radio cell.

In Example 36, the subject matter of any of Examples 1 to 35 may optionally further include, wherein the one or more input parameters includes a number of active users of the mobile radio cell.

In Example 37, the subject matter of any of Examples 1 to 36 may optionally further include, wherein the one or more input parameters includes a traffic metric of the mobile radio cell.

In Example 38, the subject matter of any of Examples 1 to 37 may optionally further be configured to receive a RAN operator preference message, wherein the updated quantization scheme is further based on the RAN operator preference message.

In Example 39, the subject matter of any of Examples 1 to 38 may optionally further include, wherein the RAN operator preference message includes a list of one or more radio resource management (RRM) algorithms.

In Example 40, the subject matter of any of Examples 1 to 39 may optionally further include, wherein the RAN operator preference message further includes a minimum threshold metric for the performance associated with at least one of the one or more RRMs.

In Example 41, the subject matter of any of Examples 1 to 40 may optionally further include, wherein the RAN operator preference message further includes a list of mobile radio cells associated with at least one of the one or more RRMs radio cells.

In Example 42, the subject matter of any of Examples 1 to 41 may optionally be further configured to: determine a pattern of the determined change in RAN properties; and wherein the updated quantization scheme is further determined based on the pattern.

In Example 43, the subject matter of any of Examples 1 to 42 may optionally further include, wherein the pattern of the determined change in RAN properties is based on a location of one or more cells of the RAN.

In Example 44, the subject matter of any of Examples 1 to 43 may optionally further include, wherein the updated quantization scheme reduces a computation requirement of the RRM algorithm as compared to the quantization scheme.

In Example 45, the subject matter of any of Examples 1 to 44 may optionally further include, wherein the updated quantization scheme reduces a memory requirement of the RRM algorithm as compared to the quantization scheme.

In Example 46, a method including: receiving a request message to update a radio access network (RAN) quantization scheme; determining an updated quantization scheme based on properties of a RAN; determining if the updated quantization scheme satisfies a RAN performance criterion; and generating a message including instructions for the updated quantization scheme.

In Example 47, the subject matter of Example 46 may optionally further include, wherein the request message is sent by a radio resource management (RRM) algorithm.

In Example 48, the subject matter of any of Examples 46 and 47 may optionally further include, wherein the request message is sent in response to a change in RAN properties.

In Example 49, the subject matter of any of Examples 46 to 48 may optionally further include, wherein the request message is sent at a time interval.

In Example 50, the subject matter of any of Examples 46 to 49 may optionally further include, wherein the RRM algorithm is a load prediction algorithm.

In Example 51, the subject matter of any of Examples 46 to 50 may optionally further include, wherein the RRM algorithm is a spectral efficiency prediction algorithm.

In Example 52, the subject matter of any of Examples 46 to 51 may optionally further include, wherein the RRM algorithm is a traffic prediction algorithm.

In Example 53, the subject matter of any of Examples 46 to 52 may optionally further include, wherein the instructions are part of a RAN intelligent controller (RIC).

In Example 54, the subject matter of any of Examples 46 to 53 may optionally further include, wherein the RIC is a near-real time RIC.

In Example 55, the subject matter of any of Examples 46 to 54 may optionally further include, wherein the RIC is a non-real time RIC.

In Example 56, the subject matter of any of Examples 46 to 55 may optionally further include, wherein the updated quantization scheme includes more bits than the RAN quantization scheme.

In Example 57, the subject matter of any of Examples 46 to 56 may optionally further include, wherein the updated quantization scheme includes less bits than the RAN quantization scheme.

In Example 58, the subject matter of any of Examples 46 to 57 may optionally further include, wherein the updated quantization scheme reduces a storage requirement of the RRM.

In Example 59, the subject matter of any of Examples 46 to 58 may optionally further include, wherein the updated quantization scheme reduces a computation requirement of the RRM.

In Example 60, the subject matter of any of Examples 46 to 59 may optionally further include, wherein the reduced computation requirement reduces a time to generate a prediction.

In Example 61, the subject matter of any of Examples 46 to 60 may optionally further include, wherein the memory and the processor are part of a base station.

In Example 62, the subject matter of any of Examples 46 to 61 may optionally further include, wherein the RRM is configured to determine a change in RAN properties.

In Example 63, the subject matter of any of Examples 46 to 62 may optionally further include, determining the updated quantization scheme based on RAN operator preferences.

In Example 64, the subject matter of any of Examples 46 to 63 may optionally further include, obtaining the RAN performance criterion; determining a performance of the updated quantization scheme; comparing the performance of the updated quantization scheme with the RAN performance criterion to determine if the updated quantization scheme satisfies the RAN performance criterion.

In Example 65, the subject matter of any of Examples 46 to 64 may optionally further include, wherein the RAN properties are based on a learned pattern of the RAN.

In Example 66, the subject matter of any of Examples 46 to 65 may optionally further include, wherein the learned pattern of the RAN is based on a time of day.

In Example 67, the subject matter of any of Examples 46 to 66 may optionally further include, wherein the learned pattern of the RAN is based on a location of one or more cells of the RAN.

In Example 68, the subject matter of any of Examples 46 to 67 may optionally further include, wherein the updated quantization scheme minimizes the computation requirement of the RRM algorithm.

In Example 69, the subject matter of any of Examples 46 to 68 may optionally further include, wherein the updated quantization scheme minimizes the memory requirement of the RRM algorithm.

In Example 70, the subject matter of any of Examples 46 to 69 may optionally further include, wherein the processor is further configured send the message to the RRM algorithm.

In Example 71, the subject matter of any of Examples 46 to 70 may optionally further include, wherein the updated quantization scheme is associated with a cell or group of cells of the RAN.

In Example 72, the subject matter of any of Examples 46 to 71 may optionally further include, wherein the updated quantization scheme includes a bit width.

In Example 73, the subject matter of any of Examples 46 to 72 may optionally further include, wherein the bit width is selected from a set of bit widths.

In Example 74, the subject matter of any of Examples 46 to 73 may optionally further include, wherein the processor is further configured to determine an improvement metric for the RRM.

In Example 75, the subject matter of any of Examples 46 to 74 may optionally further include, wherein the improvement metric is associated with a bit width of the updated quantization scheme.

In Example 76, the subject matter of any of Examples 46 to 75 may optionally further include, wherein the updated quantization scheme is associated with the group of cells of the RAN.

In Example 77, the subject matter of any of Examples 46 to 76 may optionally further include, determining a bit width of the updated quantization scheme.

In Example 78, the subject matter of any of Examples 46 to 77 may optionally further include, wherein the bit width is determined from a set of bit widths.

In Example 79, the subject matter of any of Examples 46 to 78 may optionally further include, determining a radio resource management (RRM) performance metric based on the updated quantization scheme; and replace the RAN quantization scheme with the updated quantization scheme based on the RRM performance metric.

In Example 80, one or more non-transitory computer-readable media storing instructions thereon that, when executed by one or more processors, direct the one or more processors to perform the methods according to one of examples 46 to 79.

In Example 81, a system comprising one or more devices according to any of Examples 1-45, the system configured to implement a method according to any of Examples 46 to 79.

In Example 82, a means for implementing any of the Examples 1 to 45.

In Example 83, a wireless communication device including a memory configured to store instructions; a processor coupled to the memory configured to execute the instructions stored on the memory, wherein the instructions are configured to: receive a request message to update a radio access network (RAN) quantization scheme; determine an updated quantization scheme based on properties of a RAN; determine if the updated quantization scheme satisfies a RAN performance criterion; and generate a message including instructions for the updated quantization scheme.

In Example 84, the subject matter of Example 83 may optionally be further configured to receive the request message from a radio resource management (RRM) algorithm, wherein the request message is generated includes changes in RAN environment properties.

In Example 85, the subject matter of any of Examples 83 and 84 may optionally further include, wherein the request message includes a request for a quantization scheme for one of a load prediction, a spectral efficiency prediction, a traffic prediction, a power saving prediction, or a channel feedback prediction algorithm.

In Example 86, the subject matter of any of Examples 83 to 85 may optionally further include, wherein the instructions are executed as part of a near-real time or non-real time RAN intelligent controller (RIC).

In Example 87, the subject matter of any of Examples 83 to 86 may optionally further include, a memory configured to store instructions; a processor coupled to the memory configured to execute the instructions stored on the memory, wherein the instructions are configured to: determine a change in radio access network (RAN) properties; obtain a RAN performance criterion; determine an updated quantization scheme for a radio resource management (RRM) algorithm based on the changed RAN properties; generate a RAN performance prediction based on the updated quantization scheme; compare the RAN performance prediction to the RAN performance criterion to determine if the predicted performance satisfies the RAN performance criterion; and replace a quantization scheme of the RRM with the updated quantization scheme.

In Example 88, the subject matter of any of Examples 83 to 87 may optionally further include, wherein the RAN properties are based on an RRM training.

In Example 89, the subject matter of any of Examples 83 to 88 may optionally further include, wherein the learned pattern of the RAN is associated with a time of day or a location of the one or more cells of the RAN.

In Example 90, the subject matter of any of Examples 83 to 89 may optionally further include, wherein the updated quantization scheme reduces a computation requirement or a memory requirement of the RRM algorithm as compared to the quantization scheme.

In Example 91 a method including receiving a quantization configuration request message to update a radio access network (RAN) quantization scheme; determining an updated quantization scheme based on properties of a RAN; determining if the updated quantization scheme satisfies a RAN performance criterion; and generating a message including instructions for the updated quantization scheme.

In Example 92, the subject matter of Example 91 may optionally further include, determining a group of cells of the RAN, wherein the updated quantization scheme is associated with the group of cells of the RAN.

In Example 93, the subject matter of any of Examples 91 and 92 may optionally further include, determining a bit width of the updated quantization scheme.

In Example 94, a method including receiving a quantization configuration identification request message from one or more RAN RRM algorithms, wherein each RRM algorithm is associated with one or more cells, and wherein the message includes a list of attributes corresponding to one or more input features of the RRM algorithm; determining a cell environment for the one or more cells; determining the model input parameters and architecture for the RRM algorithm; and generating an optimal quantization configuration for corresponding per cell/group of cell model of RRM algorithm based on the cell environment and model input parameters.

In Example 95, the subject matter of Example 94 may optionally further include, receiving operator preferences for cells associated with the one or more RAN RRM algorithms.

In Example 96, the subject matter of any of Examples 94 and 95 may optionally further include, determining the current quantization scheme does not meet minimum requirements for the RRM algorithm; and updating a current quantization scheme to meet minimum requirement of the RRM algorithm.

In Example 97, the subject matter of any of Examples 94 to 96 may optionally further include, identifying the optimal quantization scheme for AI/ML model to maximize the long term objective of minimizing compute/power while obtaining reasonable RAN performance.

In Example 98, the subject matter of any of Examples 94 to 97 may optionally further include, wherein RAN performance includes per cell/group-of-cells throughput, cell spectral efficiency, latency, user throughput, user spectral efficiency.

In Example 99, the subject matter of any of Examples 94 to 98 may optionally further include, wherein the quantization scheme is configured to minimize actual radio and baseband power consumption, CPU usage, or memory usage per cell.

In Example 100, the subject matter of any of Examples 94 to 99 may optionally further include, wherein the quantization scheme includes a bit-width and type of quantization; wherein the type of quantization may be linear or non-linear quantization.

In Example 101, the subject matter of any of Examples 94 to 100 may optionally further include, wherein the method is implemented as a machine learning algorithm.

In Example 102, the subject matter of any of Examples 94 to 101 may optionally further include, wherein the implements a Reinforcement Learning algorithm, where appropriate quantization configuration is identified for the per cell/group of cell RRM algorithm model based on maximizing long term objective of cell throughput and power usage.

While aspects of this disclosure have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A wireless communication device comprising:
a memory configured to store instructions;
a processor coupled to the memory configured to execute the instructions stored on the memory, wherein the instructions are configured to:
receive a request message to update a radio access network (RAN) quantization scheme;
determine an updated quantization scheme based on properties of a RAN;
determine if the updated quantization scheme satisfies a RAN performance criterion; and
generate a message including instructions for the updated quantization scheme.

2. The wireless communication device of claim 1, further configured to receive the request message from a radio resource management (RRM) algorithm.

3. The wireless communication device of claim 2,
wherein the request message includes one or more input parameters of the RRM algorithm, wherein the input parameters are associated with a mobile radio cell of the RAN.

4. The wireless communication device of claim 3,
wherein the one or more input parameters includes a downlink (DL) physical resource block (PRB) utilization metric of the mobile radio cell.

5. The wireless communication device of claim 3,
wherein the one or more input parameters includes a number of active users of the mobile radio cell.

6. The wireless communication device of claim 3,
wherein the one or more input parameters includes a traffic metric of the mobile radio cell.

7. The wireless communication device of claim 1, further configured to receive a RAN operator preference message, wherein the updated quantization scheme is further based on the RAN operator preference message.

8. The wireless communication device of claim 7,
wherein the RAN operator preference message includes a list of one or more radio resource management (RRM) algorithms.

9. The wireless communication device of claim 8,
wherein the RAN operator preference message further includes a minimum threshold metric for the performance associated with at least one of the one or more RRMs.

10. The wireless communication device of claim 8,
wherein the RAN operator preference message further includes a list of mobile radio cells associated with at least one of the one or more RRMs radio cells.

11. A wireless communication device comprising:
a memory configured to store instructions;
a processor coupled to the memory configured to execute the instructions stored on the memory, wherein the instructions are configured to:
determine a change in radio access network (RAN) properties;
obtain a RAN performance criterion;
determine an updated quantization scheme for a radio resource management (RRM) algorithm based on the changed RAN properties;
generate a RAN performance prediction based on the updated quantization scheme;
compare the RAN performance prediction to the RAN performance criterion to determine if the predicted performance satisfies the RAN performance criterion; and
replace a quantization scheme of the RRM with the updated quantization scheme.

12. The wireless communication device of claim 11, further configured to:
determine a pattern of the determined change in RAN properties; and
wherein the updated quantization scheme is further determined based on the pattern.

13. The wireless communication device of claim 12, wherein the pattern of the determined change in RAN properties is based on a location of one or more cells of the RAN.

14. The wireless communication device of claim 11,
wherein the updated quantization scheme reduces a computation requirement of the RRM algorithm as compared to the quantization scheme.

15. The wireless communication device of claim 11,
wherein the updated quantization scheme reduces a memory requirement of the RRM algorithm as compared to the quantization scheme.

16. A method comprising:
receiving a quantization configuration request message to update a radio access network (RAN) quantization scheme;
determining an updated quantization scheme based on properties of a RAN;
determining if the updated quantization scheme satisfies a RAN performance criterion; and
generating a message including instructions for the updated quantization scheme.

17. The method of claim 16, further comprising:
determining group of cells of the RAN, wherein the updated quantization scheme is associated with the group of cells of the RAN.

18. The method of claim 17, further comprising:
determining a bit width of the updated quantization scheme.

19. The method of claim 18, wherein the bit width is determined from a set of bit widths.

20. The method of claim 16, further comprising:
determining a radio resource management (RRM) performance metric based on the updated quantization scheme; and
replace the RAN quantization scheme with the updated quantization scheme based on the RRM performance metric.
